(19) United States
(12) Patent Application Publication
(10) Pub. No.: US 2011/0248617 A1
(43) Pub. Date: Oct. 13, 2011

(54) REFLECTIVE LIGHT EMITTING DIODE LAMP

(75) Inventors: Shih-Che TSENG, Hsinchu (TW); Mao-Sung HSU, Hsinchu (TW); Chen-Pin CHEN, Hsinchu (TW)

(73) Assignee: TYNTEK CORPORATION, Hsinchu (TW)

(21) Appl. No.: 12/900,575

(22) Filed: Oct. 8, 2010

(30) Foreign Application Priority Data
Apr. 12, 2010 (EM) 001693425
Jun. 25, 2010 (EM) 001724311

(51) Int. Cl. H01J 61/52; H01K 1/26

(52) U.S. Cl. 313/46; 313/113

(57) ABSTRACT

A reflective LED lamp includes a metallic shell, a reflecting member, and an LED unit. The metallic shell includes a surrounding wall formed with a mounting hole unit, and an accommodating space defined by the surrounding wall. The reflecting member is disposed within the accommodating space, and includes a reflection region unit configured as at least one concaved curve surface. The LED unit is disposed within the mounting hole unit in the shell for emitting light onto the reflection region unit of the reflecting member, so that the light is reflected by the reflection region unit out of the shell.

### CROSS-REFERENCE TO RELATED APPLICATION

This application claims priority of European Community Design No. 001693425, filed on Apr. 12, 2010, and European Community Design No. 001724311, filed on Jun. 25, 2010.

### BACKGROUND OF THE INVENTION

1. Field of the Invention

This invention relates to a lamp, and more particularly to a reflective light emitting diode (LED) lamp.

2. Description of the Related Art

Referring to FIG. 1, a conventional reflective lamp 1 disclosed in Taiwanese Patent Publication No. 200933075 (Application No. 97102136) includes a metallic sleeve 11, and a conical reflecting surface 12 disposed at the center of an end wall of the sleeve 11. A surrounding wall 111 of the sleeve 11 is formed with a mounting hole 112 for receiving an LED 13.

A light 131 emitted from the LED 13 is incident on the conical reflecting surface 12 to form reflected light 132, and is transmitted out of the sleeve 11.

Since the sleeve 11 is metallic, heat can be dissipated quickly from the LED 13. Furthermore, since the light 132 transmitted out of the sleeve 11 is a reflected light, glare can be avoided.

### SUMMARY OF THE INVENTION

The object of this invention is to provide a reflective light emitting diode lamp that has a good heat-dissipating effect and that includes a non-conical light-reflecting surface capable of reflecting light before the light is transmitted out of the lamp, so as to avoid glare.

According to this invention, a reflective LED lamp comprises:

a metallic shell including a surrounding wall formed with a mounting hole unit, and an accommodating space defined by the surrounding wall;

a reflecting member disposed within the accommodating space and including a reflection region unit configured as at least one concaved curve surface; and

an LED unit disposed within the mounting hole unit in the shell for emitting light onto the reflection region unit of the reflecting member, so that the light is reflected by the reflection region unit out of the shell.

Since the LED unit is disposed within the metallic shell, heat can be dissipated quickly therefrom during use of the lamp. Furthermore, since the light is reflected by the reflection region unit before it is transmitted out of the shell, glare is avoided.

### BRIEF DESCRIPTION OF THE DRAWINGS

These and other features and advantages of this invention will become apparent in the following detailed description of a preferred embodiment of this invention, with reference to the accompanying drawings, in which:

FIG. 1 is a schematic view of a conventional reflective lamp disclosed in Taiwanese Patent Publication No. 200933075;

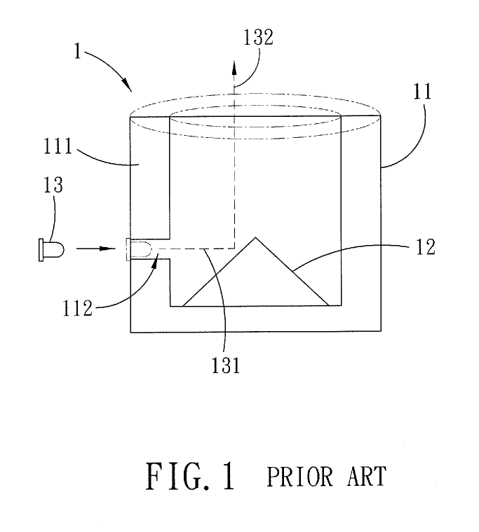

FIG. 2 is a perspective view of the preferred embodiment of a reflective LED lamp according to this invention, a light-permeable cover being shown by phantom lines;

FIG. 3 is a top view of the preferred embodiment, the light-permeable cover being removed for brevity;

FIG. 4 is a partly sectional side view of the preferred embodiment, illustrating light paths; and

FIG. 5 is a sectional view of the preferred embodiment, illustrating the light paths.

### DETAILED DESCRIPTION OF THE PREFERRED EMBODIMENT

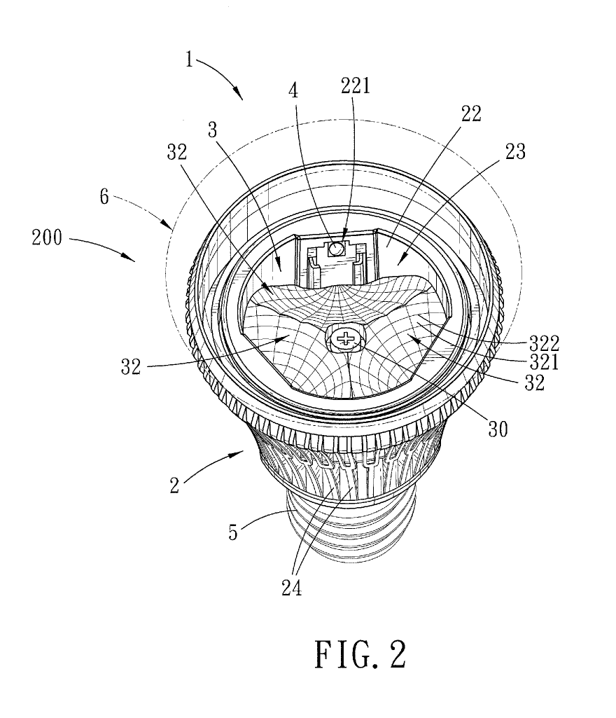

Referring to FIG. 2, the preferred embodiment of a reflective LED lamp 200 according to this invention includes a heat-dissipating metallic shell 2, a reflecting member 3, and an LED unit including a plurality of LEDs 4.

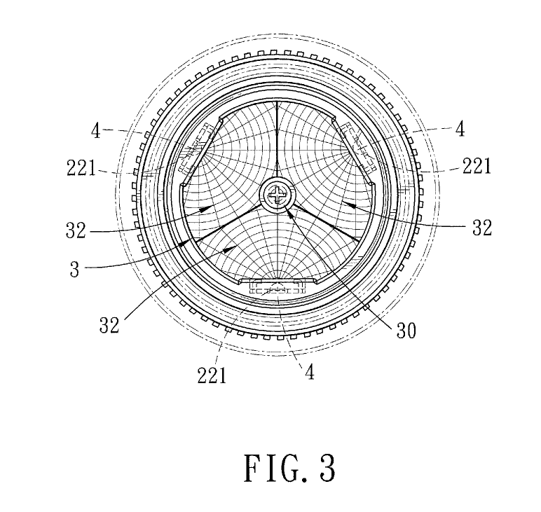

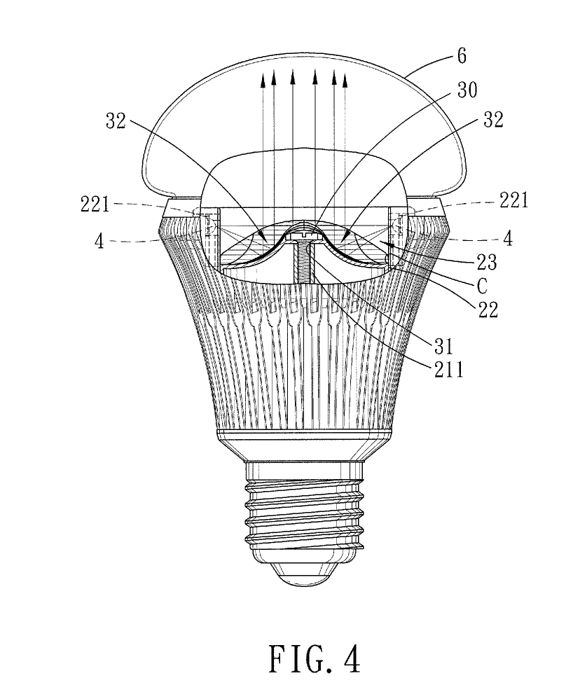

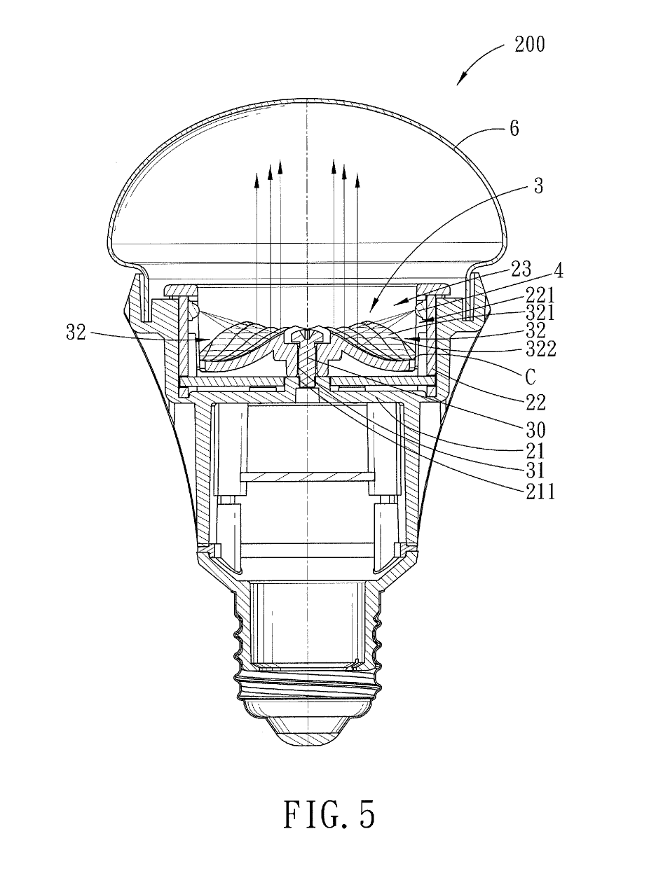

With further reference to FIGS. 3, 4, and 5, the shell 2 is made of a thermally conductive material, such as copper, and includes a base wall 21 (see FIG. 5), and a surrounding wall 22 connected integrally to an outer periphery of the base wall 21 to define an upwardly opening accommodating space 23. The reflecting member 3 is made of glass, and is disposed within the accommodating space 23. A bolt 30 extends through a central hole 31 in the reflecting member 3 to engage a threaded hole 211 in the base wall 21, such that the reflecting member 3 is secured on the base wall 21 and in the accommodating space 23.

The reflecting member 3 has a reflection region unit including a plurality of interconnected reflection regions each configured as a concaved curve surface. The surrounding wall 22 is formed with a mounting hole unit including a plurality of angularly equidistant mounting holes 221 arranged along a circle. The reflection regions 32 correspond respectively to the mounting holes 221. Each of the LEDs 4 is mounted on a circuit board (not shown), and is connected electrically to a conductive lamp base 5 of the shell 2 by a power transmission cable (not shown). As such, the LEDs 4 can emit light therefrom when electricity is supplied to the circuit boards. The LEDs 4 are located respectively within the mounting holes 221 for emitting light onto the reflection regions 32, respectively. The light incident on the reflection regions 32 is reflected out of the shell 2 through a light-permeable cover 6 mounted on a top end of the sleeve 2.

Since the LEDs 4 are disposed respectively within the mounting holes 221 in the surrounding wall 22 of the metallic shell 2, heat can be dissipate quickly from the LEDs 4 via the shell 2. The shell 2 further includes a plurality of heat-dissipating fins 24 extending from an outer surface of the surrounding wall 22 of the shell 2 for promoting the heat-dissipating effect of the shell 2. Since the LEDs 4 are concealed within the shell 2, glare resulting from looking directly at the LEDS 4 can be avoided.

Each of the LEDs 4 is disposed at a focal point of the corresponding reflection region 32, so that the light beams reflected by the reflection regions 32 are parallel to each other. Since the mounting holes 221 are angularly equidistant, the reflected light has a symmetrical and uniform light shape. Each of the reflection regions 32 defines a curvature center (C), and has a plurality of reflecting surfaces 321 disposed above the curvature center (C). Any two adjacent ones of the reflecting surfaces 321 are interconnected by a connecting portion 322. Areas of the reflecting surfaces 321 of each of the reflection regions 32 increase gradually in an upward direction, and inclination angles of the reflecting surfaces 321 of each of the reflection regions 32 also increase gradually in the upward direction, so as to optimize the light shape of the light reflected by the reflection regions 32, thereby avoiding glare.

In this embodiment, the lamp 200 includes three reflection regions 32, three mounting holes 221, and three LEDs 4. Alternately, the number of these components may be changed to one, two, or more than three.

In view of the above, the lamp 200 of this invention has the following advantages:

(1) Heat can be dissipated quickly from the LEDs 4 through the metallic shell 2.
(2) The LEDs 4 are kept out of direct sight of the user to avoid glare resulting from the direct sight.
(3) Since the LEDs 4 are disposed respectively at the focal points of the reflection regions 32, the light beams reflected by the reflection regions 32 are parallel to each other.
(4) The mounting holes 221 in the surrounding wall 22 are angularly equidistant, and the reflection regions 32 correspond respectively to the mounting holes 221. As such, when light is reflected by the reflection regions 32, it has a relatively symmetrical and uniform light shape.

It should be noted that, due to the presence of the bolt 30, there are no parallel light beams reflected from the center of the reflecting member 3. To solve this problem, the shape of a surface portion of each of the reflection regions 32 can be changed so that a plurality of inclined light beams are reflected by the surface portion to thereby eliminate the dark central portion of light emitted from the lamp 200. Alternatively, the inclined light beams may be reflected outwardly to increase the area of the light emitted from the lamp 200.

With this invention thus explained, it is apparent that numerous modifications and variations can be made without departing from the scope and spirit of this invention. It is therefore intended that this invention be limited only as indicated by the appended claims.

We claim:

1. A reflective LED lamp comprising:
a metallic shell including a surrounding wall formed with a mounting hole unit, and an accommodating space defined by said surrounding wall;
a reflecting member disposed within said accommodating space and including a reflection region unit configured as at least one concaved curve surface; and
an LED unit disposed within said mounting hole unit in said shell for emitting light onto said reflection region unit of said reflecting member, so that the light is reflected by said reflection region unit out of said shell.

2. The reflective LED lamp as claimed in claim 1, wherein said mounting hole unit of said shell includes amounting hole, said reflection region unit of said reflecting member includes a reflection region configured as said concaved curve surface, and said lamp comprises an LED.

3. The reflective LED lamp as claimed in claim 2, wherein said reflection region has a focal point, said LED being disposed at said focal point.

4. The reflective LED lamp as claimed in claim 3, wherein said reflection region further has a plurality of reflecting surfaces, any two adjacent ones of which are interconnected.

5. The reflective LED lamp as claimed in claim 4, wherein said reflection region defines a curvature center disposed under said LED, said reflecting surfaces being disposed above said curvature center, areas of said reflecting surfaces increasing gradually in an upward direction.

6. The reflective LED lamp as claimed in claim 5, wherein inclination angles of said reflecting surfaces increase gradually in the upward direction.

7. The reflective LED lamp as claimed in claim 6, wherein said shell further includes a plurality of heat-dissipating fins extending from an outer surface of said surrounding wall.

8. The reflective LED lamp as claimed in claim 7, wherein:
said mounting hole unit of shell includes a plurality of mounting holes;
said reflection region unit of reflecting member includes a plurality of reflection regions each configured as said concaved curve surface; and
said reflective LED lamp comprises a plurality of LEDs disposed respectively within said mounting holes in said shell, each of said LEDs emitting the light onto a respective one of said reflection regions of said reflecting member, so that the light is reflected out of said shell.

9. The reflective LED lamp as claimed in claim 8, wherein each of said reflection regions has a focal point, said LEDs being disposed respectively at said focal points of said reflection regions.

10. The reflective LED lamp as claimed in claim 9, wherein each of said reflection regions further has a plurality of reflecting surfaces, any two adjacent ones of which are interconnected.

11. The reflective LED lamp as claimed in claim 10, wherein each of said reflection regions defines a curvature center disposed under a corresponding one of said LEDs, said reflecting surfaces of each of said reflection regions being disposed above said curvature center of a corresponding one of said reflection regions, areas of said reflecting surfaces of each of said reflection regions increasing gradually in an upward direction.

12. The reflective LED lamp as claimed in claim 11, wherein inclination angles of said reflecting surfaces of each of said reflection regions increase gradually in the upward direction.

13. The reflective LED lamp as claimed in claim 8, wherein said shell further includes a plurality of heat-dissipating fins extending from an outer surface of said surrounding wall.
